(19) United States
(12) Patent Application Publication
(10) Pub. No.: US 2007/0110159 A1
(43) Pub. Date: May 17, 2007

(54) Method and apparatus for sub-pixel interpolation for updating operation in video coding

(75) Inventors: Xianglin Wang, Santa Clara, CA (US); Marta Karczewicz, Irving, TX (US); Justin Ridge, Sachse, TX (US); Yiliang Bao, Coppell, TX (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/504,973

(22) Filed: Aug. 15, 2006

Related U.S. Application Data
(60) Provisional application No. 60/708,509, filed on Aug. 15, 2005.

(51) Int. Cl. H04N 11/02; H04N 11/04; H04B 1/66

(52) U.S. Cl. 375/240.16; 375/240.24; 375/240.29

(57) ABSTRACT

In the video encoding and decoding of digital video sequence having a prediction operation and an update operation, the update operation includes interpolation to generate energy distributed interpolation. Prediction is carried out on each block based on motion compensated prediction with respect to a reference frame and a motion vector in order to provide a corresponding block of prediction residues. Updating is carried out on a reference video frame based on motion compensated prediction with respect to the block of prediction residues and a reverse direction of the motion vector. The interpolation filter is determined based on the motion vector and the sample values of sub-pixel are interpolated using the block prediction residues by treating the sample values outside the block of prediction residues to be zero. Interpolation is performed along horizontal direction and vertical direction separately using one dimensional interpolation filter.

### CROSS REFERENCES TO RELATED APPLICATIONS

The present invention is based on and claims priority to U.S. patent application Ser. No. 60/708,509, filed Aug. 15, 2005, assigned to the assignee of the present invention.

### FIELD OF THE INVENTION

The present invention relates generally to video coding and, specifically, to video coding using motion compensated temporal filtering.

### BACKGROUND OF THE INVENTION

For storing and broadcasting purposes, digital video is compressed, so that the resulting, compressed video can be stored in a smaller space.

Digital video sequences, like ordinary motion pictures recorded on film, comprise a sequence of still images, and the illusion of motion is created by displaying the images one after the other at a relatively fast frame rate, typically 15 to 30 frames per second. A common way of compressing digital video is to exploit redundancy between these sequential images (i.e. temporal redundancy). In a typical video at a given moment, there exists slow or no camera movement combined with some moving objects, and consecutive images have similar content. It is advantageous to transmit only the difference between consecutive images. The difference frame, called prediction error frame Eₙ, is the difference between the current frame Iₙ and the reference frame Pₙ. The prediction error frame is thus given by,
Eₙ(x,y)=Iₙ(x,y)−Pₙ(x,y).
Where n is the frame number and (x, y) represents pixel coordinates. The predication error frame is also called the prediction residue frame. In a typical video codec, the difference frame is compressed before transmission. Compression is achieved by means of Discrete Cosine Transform (DCT) and Huffman coding, or similar methods.

Since video to be compressed contains motion, subtracting two consecutive images does not always result in the smallest difference. For example, when camera is panning, the whole scene is changing. To compensate for the motion, a displacement (Δx(x, y), Δy(x, y)) called motion vector is added to the coordinates of the previous frame. Thus prediction error becomes
Eₙ(x,y)=Iₙ(x,y)−Pₙ(x+Δx(x, y),y+Δy(x, y)).

In practice, the frame in the video codec is divided into blocks and only one motion vector for each block is transmitted, so that the same motion vector is used for all the pixels within one block. The process of finding the best motion vector for each block in a frame is called motion estimation. Once the motion vectors are available, the process of calculating Pₙ(x+Δx(x, y),y+Δy(x, y)) is called motion compensation and the calculated item Pₙ(x+Δx(x, y),y+Δy(x, y)) is called motion compensated prediction.

In the coding mechanism described above, reference frame Pₙ can be one of the previously coded frames. In this case, Pₙ is known at both the encoder and decoder. Such coding architecture is referred to as closed-loop.

Pₙ can also be one of original frames. In that case the coding architecture is called open-loop. Since the original frame is only available at the encoder but not the decoder, there may be drift in the prediction process with the open-loop structure. Drift refers to the mismatch (or difference) of prediction Pₙ(x+Δx(x, y), y+Δy(x, y)) between the encoder and the decoder due to different frames used as reference. Nevertheless, open-loop structure becomes more and more often used in video coding, especially in scalable video coding due to the fact that open loop structure makes it possible to obtain a temporally scalable representation of video by using lifting-steps to implement motion compensated temporalfiltering (i.e. MCTF).

FIGS. 1a and 1b show the basic structure of MCTF using lifting-steps, showing both the decomposition and the composition process for MCTF using a lifting structure. In these figures, Iₙ and Iₙ₊₁ are original neighboring frames.

The lifting consists of two steps: a prediction step and an update step. They are denoted as P and U respectively in FIGS. 1a and 1b. FIG. 1a is the decomposition (analysis) process and FIG. 1b is the composition (synthesis) process. The output signals in the decomposition and the input signals in the composition process are H and L signals. H and L signal are derived as follows:
H=Iₙ₊₁−P(Iₙ)
L=Iₙ+U(H)
The prediction step P can be considered as the motion compensation. The output of P, i.e. P(Iₙ), is the motion compensated prediction. In FIG. 1(a), H is the temporal prediction residue of frame Iₙ₊₁ based on the prediction from frame Iₙ. H signal generally contains the temporal high frequency component of the original video signal. In the update step U, the temporal high frequency component in H is fed back to frame Iₙ in order to produce a temporal low frequency component L. For that reason, H and L are called temporal high band and low band signal, respectively.

In the composite process shown in FIG. 1b, the reconstruction frames I′ₙ and I′ₙ₊₁ are derived through the following operation:
I′ₙ=L−U(H)
I′ₙ₊₁=H+P(I′ₙ)
If signals L and H remain unchanged between the decomposition and composition processes as shown in FIGS. 1a and 1b, then Iₙ′ and Iₙ₊₁′ would be exactly the same as Iₙ and Iₙ₊₁ respectively. In that case, perfect reconstruction can be achieved with such lifting steps.

The structure shown in FIGS. 1a and 1b can also be cascaded so that a video sequence can be decomposed into multiple temporal levels. As shown in FIG. 2, two level lifting steps are performed. The temporal low band signal at each decomposition level can provide temporal scalability.

In MCTF, the prediction step is essentially a general motion compensation process, except that it is based on an open-loop structure. In such a process, a compensated prediction for the current frame is produced based on best-estimated motion vectors for each macroblock. Because motion vectors usually have sub-pixel precision, sub-pixel interpolation is needed in motion compensation. Motion vectors can have a precision of ¼ pixel. In this case, possible positions for pixel interpolation are shown in FIG. 3. FIG. 3 shows the possible interpolated pixel positions down to a quarter pixel. In FIG. 3, A, E, U and Y indicate original integer pixel positions, and c, k, m, o and w indicate half pixel positions. All other positions are quarter-pixel positions.

Typically, values at half-pixel positions are obtained by using a 6-tap filter with impulse response (1/32, −5/32, 20/32, 20/32, −5/32, 1/32). The filter is operated on integer pixel values, along both the horizontal direction and the vertical direction where appropriate. For decoder simplification, 6-tap filter is generally not used to interpolate quarter-pixel values. Instead, the quarter positions are obtained by averaging an integer position and its adjacent half-pixel positions, and by averaging two adjacent half-pixel positions as follows:
b=(A+c)/2, d=(c+E)/2, f=(A+k)/2, g=(c+k)/2, h=
(c+m)/2, i=(c+o)/2, j=(E+o)/2l=(k+m)/2, n=(m+o)/2, p=(U+k)/2, q=(k+w)/2, r=(m+w)/2, s=(w+o)/2, t=(Y+o)/2v=(w+U)/2, x=(Y+w)/2

An example of motion prediction is shown in FIG. 4a. In FIG. 4a, Aₙ represents a block in frame Iₙ and Aₙ₊₁ represents a block with the same position in frame Iₙ₊₁. Assuming Aₙ is used to predict a block Bₙ₊₁ in frame Iₙ₊₁ and the motion vector used for prediction is (Δx, Δy) as indicated in the FIG. 4a. Depending on the motion vector (Δx, Δy), Aₙ can be located at a pixel or a sub-pixel position as shown in FIG. 3. If Aₙ is located at a sub-pixel position, then interpolation of values in Aₙ is needed before it can be used as a prediction to be subtracted from block Bₙ₊₁.

### SUMMARY OF THE INVENTION

The present invention provides a simple but efficient method of update step interpolation to generate energy distributed interpolation. The interpolation scheme, according to the present invention, is performed on a block basis. For each block the operation is performed along a horizontal direction and a vertical direction separately using a one-dimensional interpolation filter. In particular, a prediction operation is carried out on each block based on motion compensated prediction with respect to a reference video frame and a motion vector in order to provide a corresponding block of prediction residues. The update operation is carried out on reference video frame based on motion compensated prediction with respect to the block of prediction residues and a reverse direction of the motion vector. Furthermore, in the update operation, the interpolation filter is determined based on the motion vector and the sample values of sub-pixel are interpolated using the block prediction residues by treating the sample values outside the block of prediction residues to be zero.

Thus, the first aspect of the present invention is a method of encoding a digital video sequence using motion compensated temporal filtering, wherein the video sequence comprises a plurality of frames and each of the frames comprises an array of pixels divided into a plurality of blocks. The encoding method includes performing a prediction operation on each block based on motion compensated prediction with respect to a reference video frame and a motion vector in order to provide a corresponding block of prediction residues, and updating the video reference frame based on motion compensated prediction with respect to the block of prediction residues and a reverse direction of the motion vector. The update operation includes determining a filter based on the motion vector and interpolating sample values of sub-pixel locations using the block of prediction residues by treating sample values outside the block to be zero. Furthermore, the interpolation is performed along a horizontal direction and a vertical direction separately using a one-dimensional interpolation filter.

The second aspect of the present invention is a method of decoding a digital video sequence from an encoded video sequence comprising a number of frames and each of the frames comprises an array of pixels divided into a plurality of blocks. The decoding method includes decoding a motion vector of a block and the prediction residues of the block, performing an update operation of a reference video frame of the block based on motion compensated prediction with respect to the prediction residues of the block and a reverse direction of the motion vector, and performing a prediction operation on the block based on motion compensated prediction with respect to the reference video frame and the motion vector. The update operation includes determining a filter based on the motion vector and interpolating sample values of sub-pixel locations using the block of prediction residues by treating sample values outside the block to be zero. Furthermore, the interpolation is performed along a horizontal direction and a vertical direction separately using a one-dimensional interpolation filter.

The third aspect of the present invention is a video encoder for encoding a digital video sequence using motion compensated temporal filtering, wherein the video sequence comprises a plurality of frames and each of the frames comprises an array of pixels divided into a plurality of blocks. The encoder includes a prediction module for performing a prediction operation on each block based on motion compensated prediction with respect to a reference video frame and a motion vector in order to provide a corresponding block of prediction residues, and an updating module for updating the video reference frame based on motion compensated prediction with respect to the block of prediction residues and a reverse direction of the motion vector. The updating module includes a software program for determining a filter based on the motion vector and for interpolating sample values of sub-pixel locations using the block of prediction residues by treating sample values outside the block to be zero. Furthermore, the interpolation is performed along a horizontal direction and a vertical direction separately using a one-dimensional interpolation filter.

The fourth aspect of the present invention is a video decoder for decoding a digital video sequence from an encoded video sequence comprising a number of frames and each of the frames comprises an array of pixels divided into a plurality of blocks. The decoder includes a decoding module for decoding a motion vector of a block and the prediction residues of the block, an updating module for performing an update operation of a reference video frame of the block based on motion compensated prediction with respect to the prediction residues of the block and a reverse direction of the motion vector, and a prediction module for performing a prediction operation on the block based on motion compensated prediction with respect to the reference video frame and the motion vector. The updating module includes a software program for determining a filter based on the motion vector and for interpolating sample values of sub-pixel locations using the block of prediction residues by treating sample values outside the block to be zero. Furthermore, the interpolation is performed along a horizontal direction and a vertical direction separately using a one-dimensional interpolation filter.

The fifth aspect of the present invention is a mobile terminal having an encoder or decoder according to the third and fourth aspect of the present invention. The mobile terminal may have both the encoder and the decoder.

The sixth aspect of the present invention is a software application product having a storage medium having a software application for use in encoding a digital video sequence using motion compensated temporal filtering, wherein the video sequence comprises a plurality of frames and each of the frames comprises an array of pixels divided into a plurality of blocks. The software application includes program code for performing a prediction operation on each block based on motion compensated prediction with respect to a reference video frame and a motion vector in order to provide a corresponding block of prediction residues, and program code for updating the video reference frame based on motion compensated prediction with respect to the block of prediction residues and a reverse direction of the motion vector. The update program code includes program code for determining a filter based on the motion vector and program code for interpolating sample values of sub-pixel locations using the block of prediction residues by treating sample values outside the block to be zero. The interpolation is performed along a horizontal direction and a vertical direction separately using a one-dimensional interpolation filter.

The seventh aspect of the present invention is a software application product comprising a storage medium having a software application for decoding a digital video sequence from an encoded video sequence comprising a number of frames and each of the frames comprises an array of pixels divided into a plurality of blocks. The software application includes program code for decoding a motion vector of a block and the prediction residues of the block, program code for performing an update operation of a reference video frame of the block based on motion compensated prediction with respect to the prediction residues of the block and a reverse direction of the motion vector, and program code for performing a prediction operation on the block based on motion compensated prediction with respect to the reference video frame and the motion vector. The program code for updating includes program code for determining a filter based on the motion vector and program code for interpolating sample values of sub-pixel locations using the block of prediction residues by treating sample values outside the block to be zero. The interpolation is performed along a horizontal direction and a vertical direction separately using a one-dimensional interpolation filter.

The present invention will become apparent upon reading the description taken in conjunction with FIGS. 5 to 15.

### BRIEF DESCRIPTION OF THE DRAWINGS

FIG. 1a shows the decomposition process for MCTF using a lifting structure.

FIG. 1b shows the composition process for MCTF using the lifting structure.

FIG. 2 shows a two-level decomposition process for MCTF using the lifting structure.

FIG. 3 shows the possible interpolated pixel positions down to a quarter-pixel.

FIG. 4a shows an example of the relationship of associated blocks and motion vectors that are used in the prediction step.

FIG. 4b shows the relationship of associated blocks and motion vectors that are used in the update step.

FIG. 5 shows the partial pixel difference of locations for blocks involved in the update step from those in the prediction step.

FIG. 6 shows an example of the interpolation process.

FIG. 7 is a block diagram showing the MCTF decomposition process.

FIG. 8 is a block diagram showing the MCTF composition process.

FIG. 9 shows a block diagram of an MCTF-based encoder.

FIG. 10 shows a block diagram of an MCTF-based decoder.

FIG. 11 is a block diagram showing the MCTF decomposition process with a motion vector filter module.

FIG. 12 is a block diagram showing the MCTF composition process with a motion vector filter module.

FIG. 13 is a flowchart illustrating part of the method of encoding, according to one embodiment of the present invention.

FIG. 14 is a flowchart illustrating part of the method of decoding, according to one embodiment of the present invention.

FIG. 15 is a block diagram of an electronic device which can be equipped with one or both of the MCTF-based encoding and decoding modules, according to the present invention.

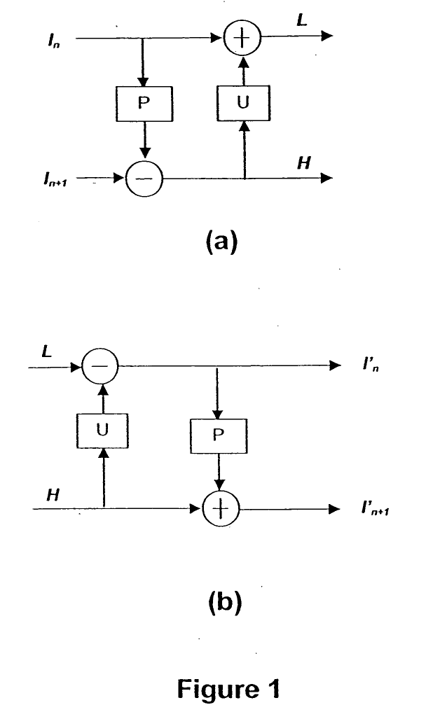

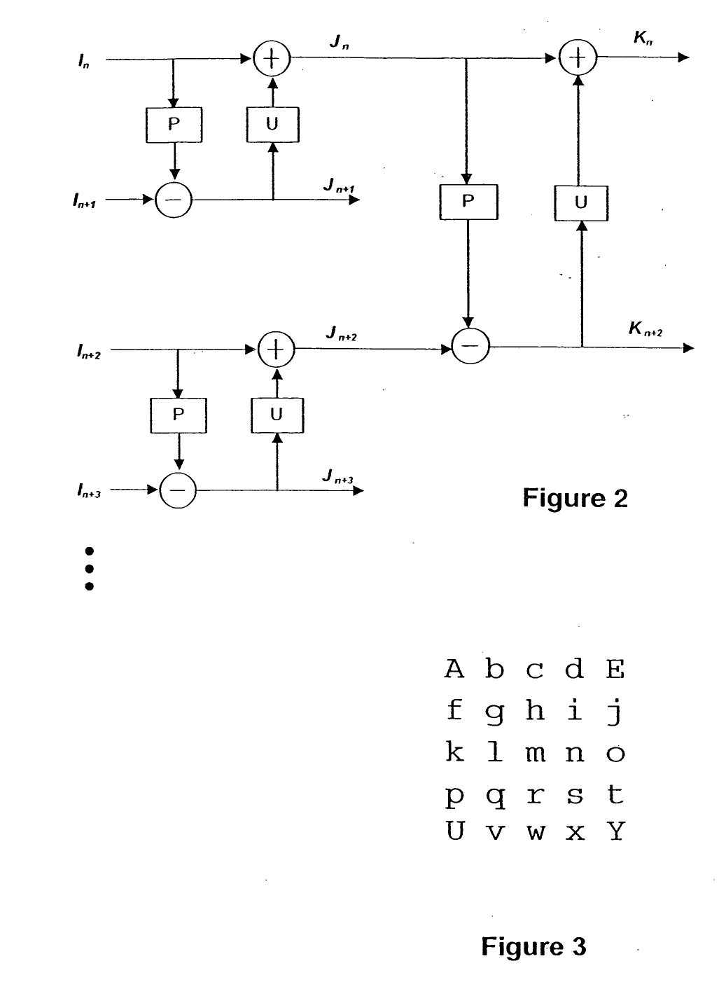

### DETAILED DESCRIPTION OF THE INVENTION

Both the decomposition and composition processes for motion compensated temporal filtering (MCTF) can use a lifting structure. The lifting consists of a prediction step and an update step.

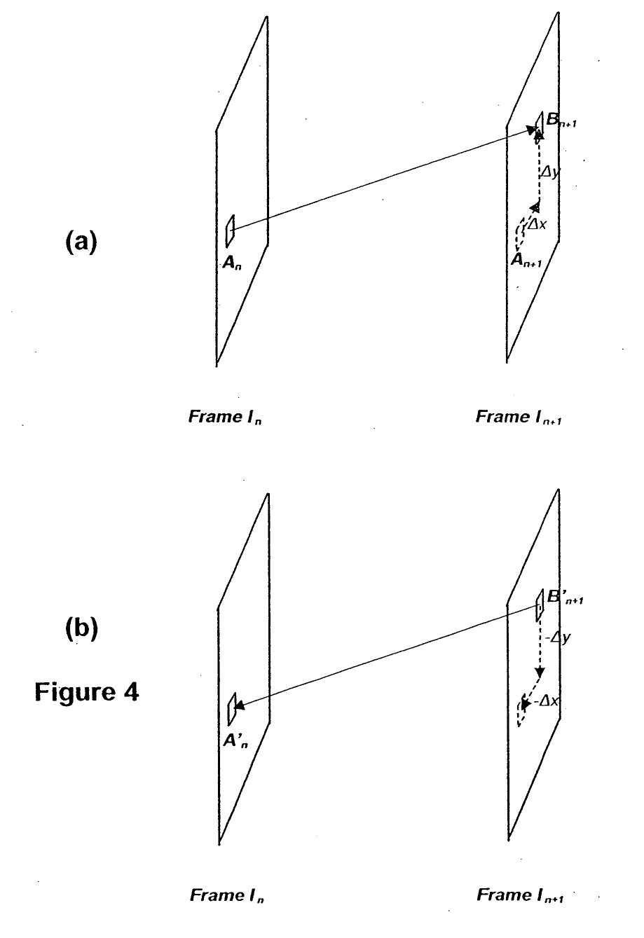

In the update step, the prediction residue at block Bₙ₊₁ can be added to the reference block along the reverse direction of the motion vectors used in the prediction step. If the motion vector is (Δx, Δy) (see FIG. 4a), then its reverse direction can be expressed as (−Δx, −Δy) which may also be considered as a motion vector. As such, the update step also includes a motion compensation process. The prediction residue frame obtained from the prediction step can be considered as being used as a reference frame. The reverse directions of those motion vectors in the prediction step are used as motion vectors in the update step. With such reference frame and motion vectors, a compensated frame can be constructed. The compensated frame is then added to frame Iₙ in order to remove some of the temporal high frequencies in frame Iₙ.

The update process is performed only on integer pixels in frame Iₙ. If Aₙ is located at a sub-pixel position, its nearest integer position block A′ₙ is actually updated according to the motion vector (−Δx, −Δy). This is shown in FIG. 4b. In that case, there is a partial pixel difference between location of block Aₙ, and A′ₙ. According to the motion vector (−Δx, −Δy), the reference block for A′ₙ in the update step (denoted as B′ₙ₊₁) is not located at an integer pixel position either. However, there will be the same partial pixel difference between the locations of block Bₙ₊₁ and block B′ₙ₊₁. For that reason, interpolation is needed for obtaining the prediction residue at block B′ₙ₊₁. Thus, interpolation is generally needed in the update step whenever the motion vector (−Δx, −Δy) does not have an integer pixel displacement for either horizontal or vertical direction.

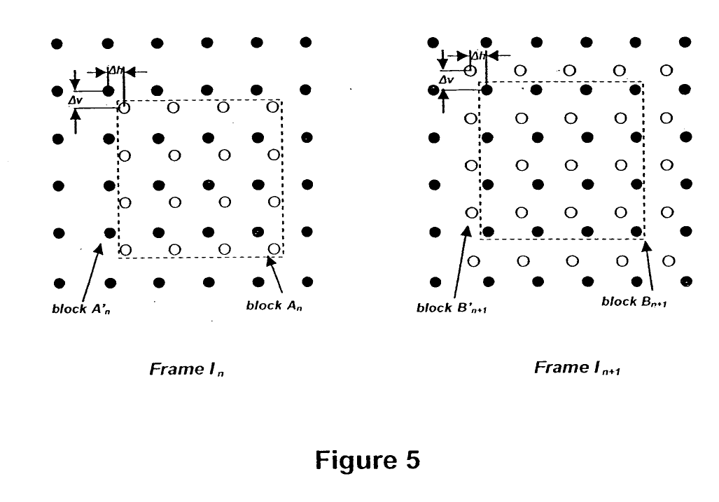

Interpolation can be performed through an energy distribution manner. More specifically, in the interpolation process, each pixel in a prediction residue block is processed individually and its contribution to the update signal from the block is calculated separately. This is shown in FIG. 5, where solid dots represent integer pixel locations and hollow dots sub-pixel locations. Block Aₙ is the reference block for block Bₙ₊₁ in the prediction step. According to the same motion vector, hollow dots shown in frame Iₙ₊₁ are corresponding to integer pixel locations in frame Iₙ. If assume bilinear filter is used in the interpolation process for update step, each pixel in block Bₙ₊₁ would have contribution to the interpolation sample value at its neighboring four sub-pixel locations. The contribution factors from a pixel to each of its four neighboring sub-pixel locations are determined by the interpolation filter coefficients. Contributions from neighboring pixels in the block to a same sub-pixel location are added up. As shown in FIG. 5, after each pixel of a prediction residue block is processed, a size of K by K block will generate update signal of size K+1 by K+1.

Similarly, if a 4-tap filter is used for update step interpolation, each pixel in block Bₙ₊₁ would have contribution to the interpolation sample value at its neighboring 16 (i.e. 4×4) sub-pixel locations. The contribution factors from a pixel to each of its 16 neighboring sub-pixel locations are determined by the interpolation filter coefficients. After each pixel of a prediction residue block is processed, a size of K by K block will generate update signal of size K+3 by K+3.

After interpolation, the update signal is added back to low pass frame (e.g. frame Iₙ in FIGS. 4a and 4b) according to the reverse direction of the motion vector used in prediction step.

For such energy distributed interpolation, if it is done pixel by pixel, the computation complexity can be significantly higher than traditional block-based interpolation.

The major difference between the energy distributed interpolation and traditional interpolation is that in such energy distributed interpolation process, each prediction residue block is processed independently without any reference to pixels neighboring to the block. However, in traditional interpolation, pixels in neighboring blocks are referenced when filtering along the boundary of a current block. Since prediction residues in neighboring blocks are not so correlated, especially when the blocks have different motion vectors, energy distributed interpolation may be more accurate or appropriate for update step than traditional interpolation schemes mentioned earlier in the description.

According to the present invention, the energy distributed interpolation is to be performed on a block basis, wherein for each block common motion vectors are shared for every pixel in the block. In the energy distributed interpolation, each prediction residue block is processed independently without any reference to pixels in its neighboring blocks. Sub-pixel locations where sample values need to be interpolated include all the locations that can be affected by the interpolation of the current block with a given filter. The filter is determined based on the motion vector. When filtering along the boundary of a block, pixels outside the current block are considered as zero pixels (i.e. pixels having a value of zero). Furthermore, the interpolation process is performed on a block-by-block basis and, for each block, sub-pixel locations are determined based on the corresponding motion vector of the block. More specifically, the interpolation operation is performed along the horizontal direction and the vertical direction separately using one dimensional interpolation filter (e.g. a 4-tap filter). The order of horizontal filtering and vertical filtering does not affect the interpolation result and therefore can be changed.

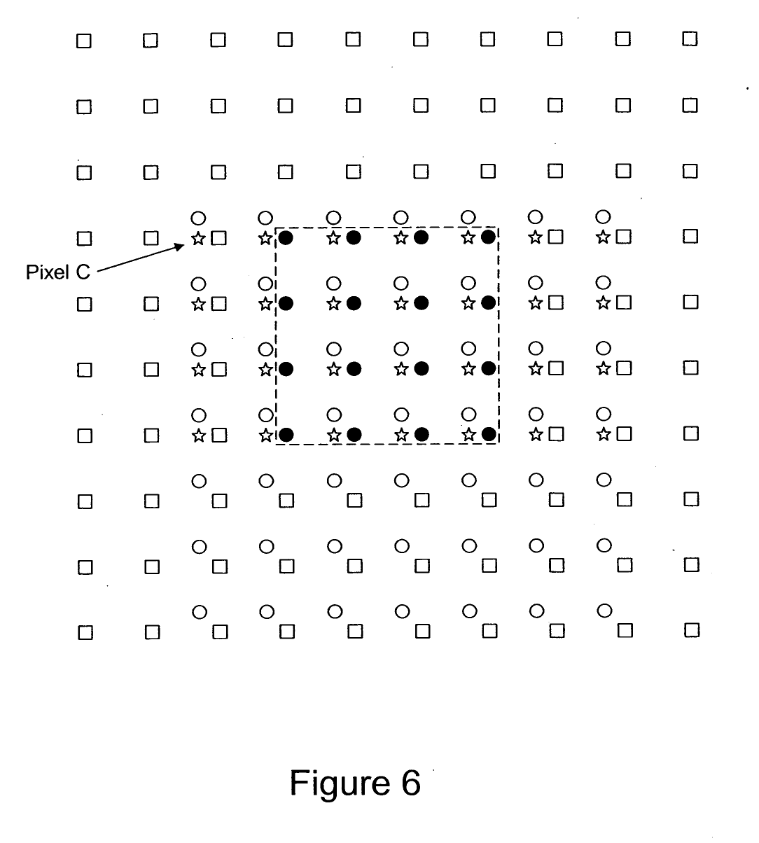

An example is shown in FIG. 6. In FIG. 6, the prediction residue block is assumed to be a 4×4 block indicated with solid dots inside the dashed rectangle. Assume a 4-tap filter is selected for interpolation of the current block. In this case, the sub-pixel locations that can be affected by the interpolation of the current block include (4+3)×(4+3) positions indicated as hollow dots in the figure. Therefore, all the (4+3)×(4+3) sub-pixel values need to be interpolated. Interpolation is performed along horizontal direction and vertical direction separately using the given filter. More specifically, if horizontal filtering is assumed to be performed first, then the sample values at locations indicated with stars in FIG. 6 are interpolated first. Based on these values, the (4+3)×(4+3) sub-pixel values indicated as hollow dots in FIG. 6 are further interpolated through vertical filtering.

When filtering along the boundary of the current block, pixels outside the current block are considered as zero pixels, which are shown as rectangles in the figure. It should be noted that, in real implementation, multiplication operation with a zero pixel in the filtering process has no effect and therefore can be omitted. For example, to obtain an interpolation value for pixel C as indicated in FIG. 6, only one multiplication is needed using a 4-tap filter. This is possible because three of the four pixels involved in the filtering process are zero pixels. It should also be noted that this block based energy distributed interpolation process generates the same interpolation result as the pixel based energy distributed interpolation method. Because the interpolation according to the present invention is performed along the horizontal direction and the vertical direction separately, it generally has a lower computation complexity.

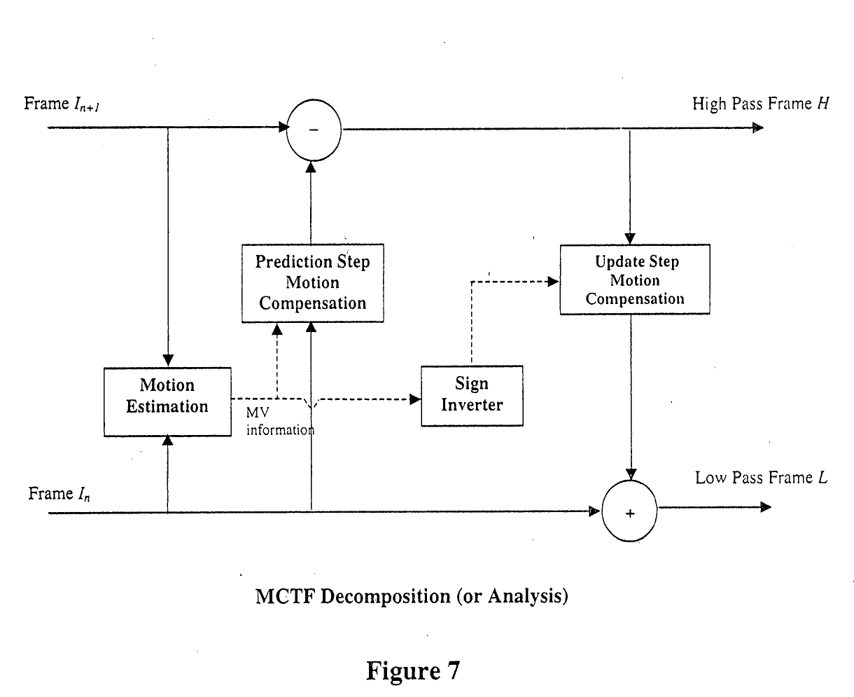

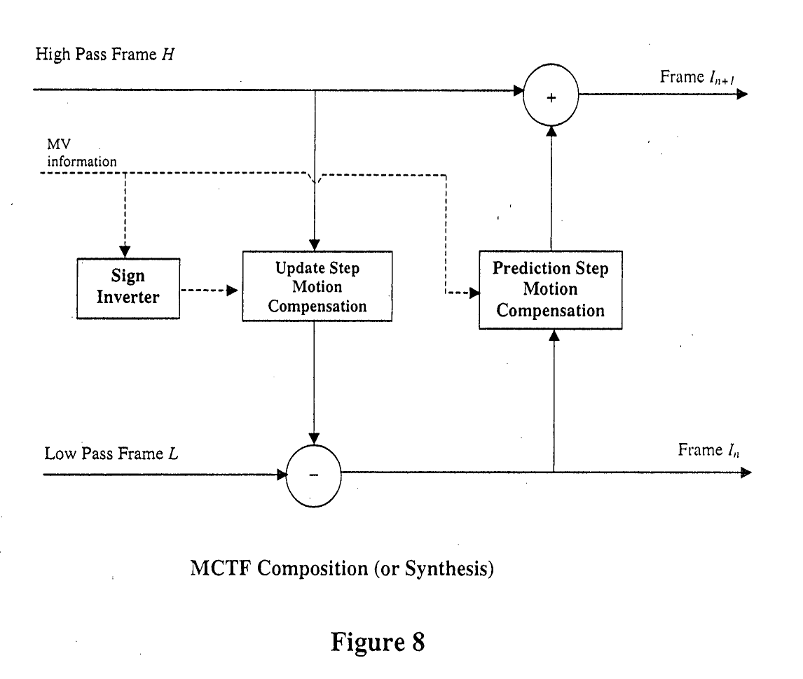

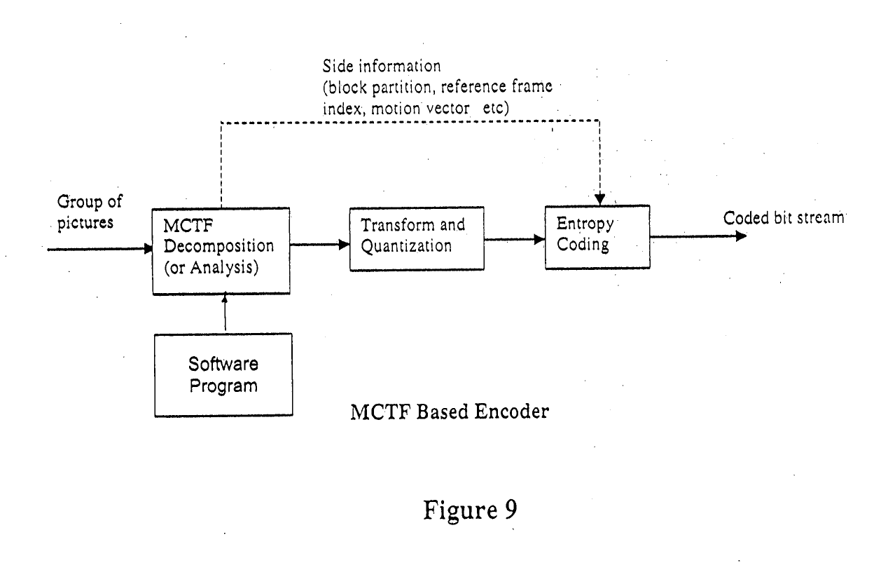

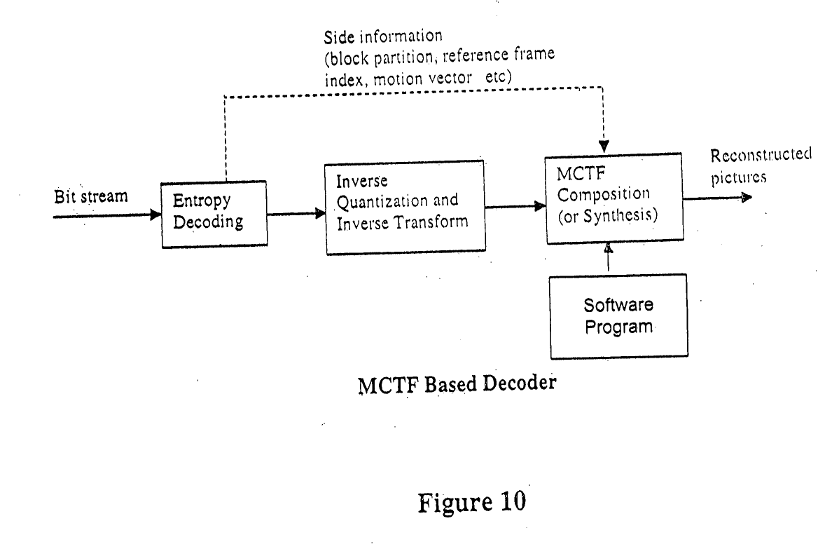

The block diagrams for MCTF decomposition (or analysis) and MCTF composition (or synthesis) are shown in FIG. 7 and FIG. 8, respectively. With the incorporation of MCTF module, the encoder and decoder block diagrams are shown in FIG. 9 and FIG. 10, respectively. Because the prediction step motion compensation process is needed whether MCTF technique is used or not, the additional module is required with the incorporation of MCTF for the update step motion compensation process. The sign inverter in FIGS. 7 and 8 is used to change the sign of motion vector components to obtain the inverse direction of the motion vector.

FIG. 9 shows a block diagram of an MCTF-based encoder, according to one embodiment of the present invention. The MCTF Decomposition module includes both the prediction step and the update step. This module generates the prediction residue and some side information including block partition, reference frame index, motion vector, etc. Prediction residue is transformed, quantized and then sent to Entropy Coding module. Side information is also sent to Entropy Coding module. Entropy Coding module encodes all the information into compressed bitstream. The encoder also includes a software program module for carrying out various steps in the MCTF decomposition processes. The software program can also be used to determine sub-pixel locations in a block based on the motion vector of the block and set the pixel value of the pixels outside of the boundary of the block to zero before horizontal filtering and vertical filtering are carried out.

FIG. 10 shows a block diagram of an MCTF-based decoder, according to one embodiment of the present invention. Through Entropy Decoding module, a bitstream is decompressed, which provides both the prediction residue and side information including block partition, reference frame index and motion vector, etc. Prediction residue is then de-quantized, inverse-transformed and then sent to MCTF Composition module. Through MCTF composition process, video pictures are reconstructed. The decoder also includes a software program module for carrying out various steps in the MCTF composition processes.

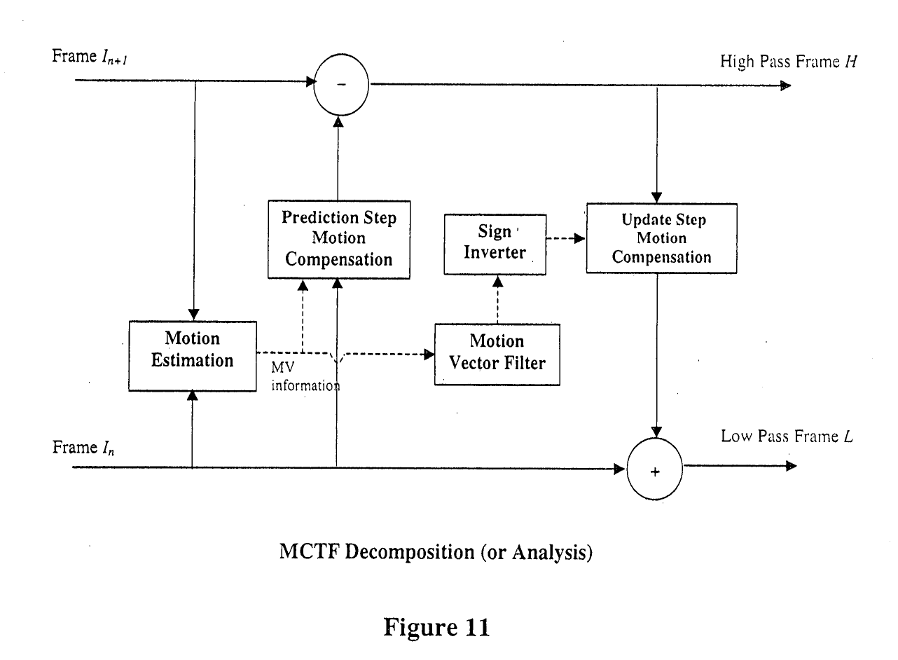

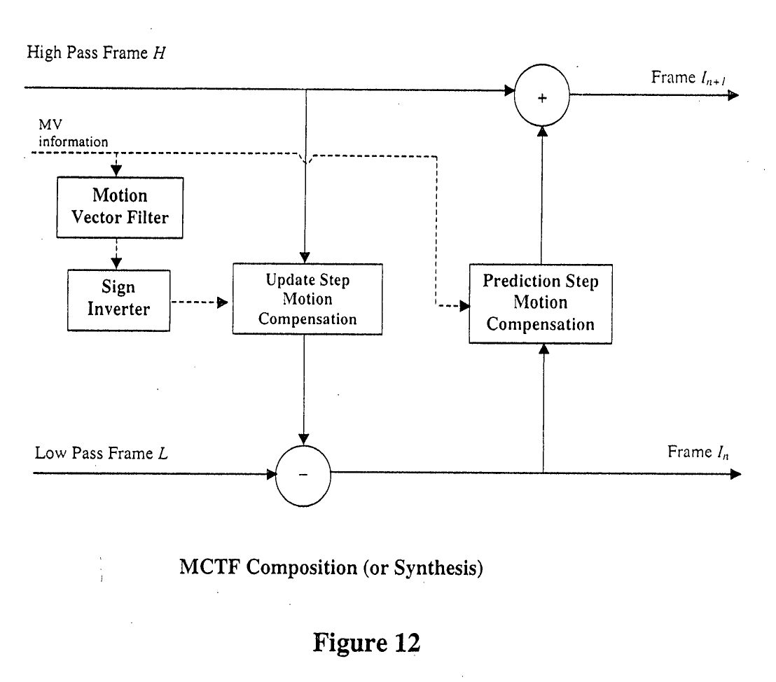

With a motion vector filter module, the MCTF decomposition and composition processes are shown in FIGS. 11 and 12, respectively, according to one embodiment of the present invention.

FIG. 11 is a block diagram showing the MCTF decomposition process, according to one embodiment of the present invention. The process includes a prediction step and an update step. In FIG. 11, Motion Estimation module and Prediction Step Motion Compensation module are used in the prediction step. Other modules are used in the update step. Motion vectors from Motion Estimation module are also used in the update step to derive motion vectors used for the update step, which is done in Sign Inverter via the Motion Vector Filter. As shown, motion compensation process is performed in both the prediction step and the update step.

FIG. 12 is a block diagram showing the MCTF composition process, according to one embodiment of the present invention. Based on received and decoded motion vector information, update motion vectors are derived in the Sign Inverter via a Motion Vector Filter. Then the same motion compensation processes as that in the MCTF decomposition process are performed. Compared with FIG. 11, it can be seen the MCTF composition is the reverse process of MCTF decomposition.

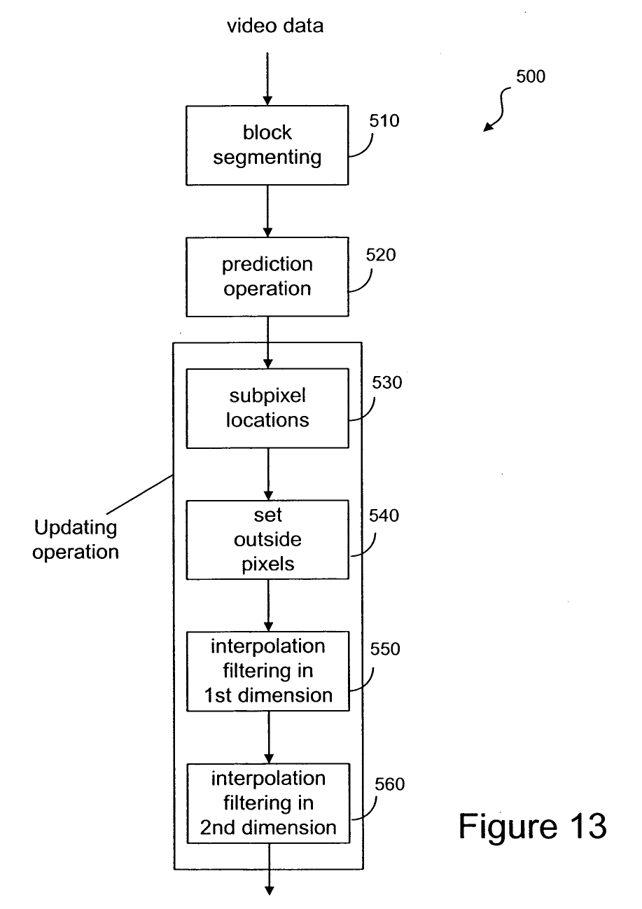

The update operation is performed according to coding blocks in the prediction residue frame. In encoding, the method is illustrated in FIG. 13. As shown in flowchart 500 in FIG. 13, as the encoding module receives video data representing of a digital video sequence of video frames, it starts at step 510 to segment a video frame into a plurality of blocks. At step 520, a prediction operation is performed on the blocks based on motion compensated prediction with respect to a reference video frame and motion vectors so as to provide corresponding blocks of prediction residue. At step 530, the sub-pixel locations are determined based on the motion vector of the block. At step 540, the pixel value of the pixels outside the boundary of the block is set to zero so that the prediction residue block is processed independently without any reference to the pixels in the neighboring blocks. At step 550, a one dimensional interpolation filter is used to carry out the interpolation filtering in one dimension. At step 560, the same or a different one dimensional interpolation filter is used to carry out the interpolation in the other direction.

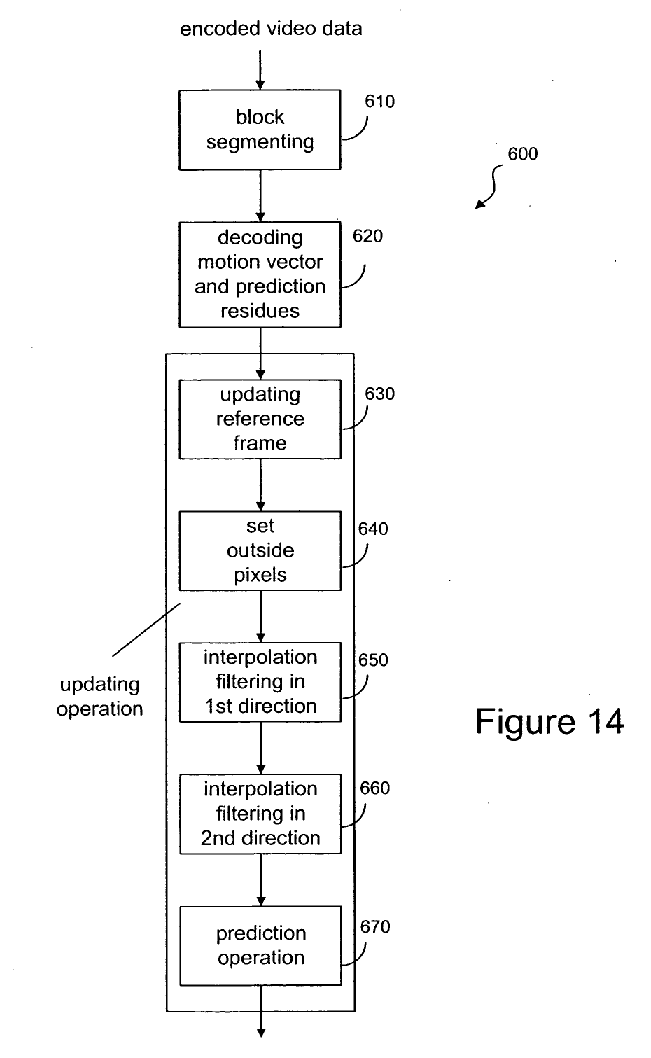

In decoding, the method is illustrated in FIG. 14. As shown in the flowchart 600 in FIG. 14, as the decoding module receives an encoded video data representing an encoded video sequence of video frames, it starts at step 610 to segment the video frame in the encoded video data into a plurality of blocks. At step 620, the decoding module decodes the motion vectors and prediction residues of the blocks. At step 630, a reference frame of the blocks is updated based on motion compensated prediction with respect to the prediction residues of the blocks and the reverse direction of the motion vectors. At step 640, the pixel value of pixels outside the boundary of each block is set to zero. At step 650, a one dimensional interpolation filter is used to carry out the interpolation filtering in one dimension. At step 660, the same or a different one dimensional interpolation filter is used to carry out the interpolation in the other direction. At step 670, a prediction operation is performed according to the coding block in the prediction frame.

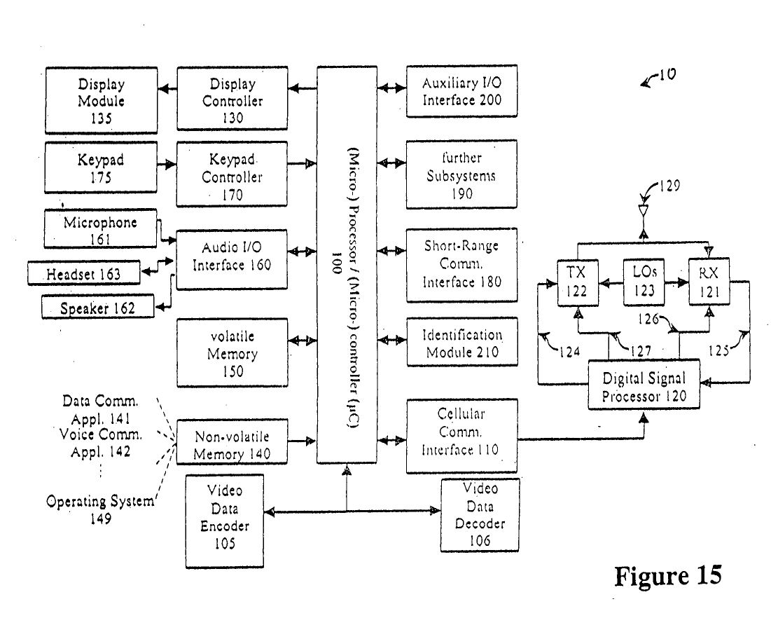

Referring now to FIG. 15, FIG. 15 shows an electronic device that equips at least one of the MCTF encoding module and the MCTF decoding module as shown in FIGS. 9 and 10. According to one embodiment of the present invention, the electronic device is a mobile terminal. The mobile device 10 shown in FIG. 15 is capable of cellular data and voice communications. It should be noted that the present invention is not limited to this specific embodiment, which represents one of a multiplicity of different embodiments. The mobile device 10 includes a (main) microprocessor or micro-controller 100 as well as components associated with the microprocessor controlling the operation of the mobile device. These components include a display controller 130 connecting to a display module 135, a non-volatile memory 140, a volatile memory 150 such as a random access memory (RAM), an audio input/output (I/O) interface 160 connecting to a microphone 161, a speaker 162 and/or a headset 163, a keypad controller 170 connected to a keypad 175 or keyboard, any auxiliary input/output (I/O) interface 200, and a short-range communications interface 180. Such a device also typically includes other device subsystems shown generally at 190.

The mobile device 10 may communicate over a voice network and/or may likewise communicate over a data network, such as any public land mobile networks (PLMNs) in form of e.g. digital cellular networks, especially GSM (global system for mobile communication) or UMTS (universal mobile telecommunications system). Typically the voice and/or data communication is operated via an air interface, i.e. a cellular communication interface subsystem in cooperation with further components (see above) to a base station (BS) or node B (not shown) being part of a radio access network (RAN) of the infrastructure of the cellular network.

The cellular communication interface subsystem as depicted illustratively in FIG. 15 comprises the cellular interface 110, a digital signal processor (DSP) 120, a receiver (RX) 121, a transmitter (TX) 122, and one or more local oscillators (LOs) 123 and enables the communication with one or more public land mobile networks (PLMNs). The digital signal processor (DSP) 120 sends communication signals 124 to the transmitter (TX) 122 and receives communication signals 125 from the receiver (RX) 121. In addition to processing communication signals, the digital signal processor 120 also provides for the receiver control signals 126 and transmitter control signal 127. For example, besides the modulation and demodulation of the signals to be transmitted and signals received, respectively, the gain levels applied to communication signals in the receiver (RX) 121 and transmitter (TX) 122 may be adaptively controlled through automatic gain control algorithms implemented in the digital signal processor (DSP) 120. Other transceiver control algorithms could also be implemented in the digital signal processor (DSP) 120 in order to provide more sophisticated control of the transceiver 121/122.

In case the mobile device 10 communications through the PLMN occur at a single frequency or a closely-spaced set of frequencies, then a single local oscillator (LO) 123 may be used in conjunction with the transmitter (TX) 122 and receiver (RX) 121. Alternatively, if different frequencies are utilized for voice/data communications or transmission versus reception, then a plurality of local oscillators can be used to generate a plurality of corresponding frequencies.

Although the mobile device 10 depicted in FIG. 15 is used with the antenna 129 as or with a diversity antenna system (not shown), the mobile device 10 could be used with a single antenna structure for signal reception as well as transmission. Information, which includes both voice and data information, is communicated to and from the cellular interface 110 via a data link between the digital signal processor (DSP) 120. The detailed design of the cellular interface 110, such as frequency band, component selection, power level, etc., will be dependent upon the wireless network in which the mobile device 10 is intended to operate.

After any required network registration or activation procedures, which may involve the subscriber identification module (SIM) 210 required for registration in cellular networks, have been completed, the mobile device 10 may then send and receive communication signals, including both voice and data signals, over the wireless network. Signals received by the antenna 129 from the wireless network are routed to the receiver 121, which provides for such operations as signal amplification, frequency down conversion, filtering, channel selection, and analog to digital conversion. Analog to digital conversion of a received signal allows more complex communication functions, such as digital demodulation and decoding, to be performed using the digital signal processor (DSP) 120. In a similar manner, signals to be transmitted to the network are processed, including modulation and encoding, for example, by the digital signal processor (DSP) 120 and are then provided to the transmitter 122 for digital to analog conversion, frequency up conversion, filtering, amplification, and transmission to the wireless network via the antenna 129.

The microprocessor/micro-controller (μC) 110, which may also be designated as a device platform microprocessor, manages the functions of the mobile device 10. Operating system software 149 used by the processor 110 is preferably stored in a persistent store such as the non-volatile memory 140, which may be implemented, for example, as a Flash memory, battery backed-up RAM, any other non-volatile storage technology, or any combination thereof. In addition to the operating system 149, which controls low-level functions as well as (graphical) basic user interface functions of the mobile device 10, the non-volatile memory 140 includes a plurality of high-level software application programs or modules, such as a voice communication software application 142, a data communication software application 141, an organizer module (not shown), or any other type of software module (not shown). These modules are executed by the processor 100 and provide a high-level interface between a user of the mobile device 10 and the mobile device 10. This interface typically includes a graphical component provided through the display 135 controlled by a display controller 130 and input/output components provided through a keypad 175 connected via a keypad controller 170 to the processor 100, an auxiliary input/output (I/O) interface 200, and/or a short-range (SR) communication interface 180. The auxiliary I/O interface 200 comprises especially USB (universal serial bus) interface, serial interface, MMC (multimedia card) interface and related interface technologies/standards, and any other standardized or proprietary data communication bus technology, whereas the short-range communication interface radio frequency (RF) low-power interface includes especially WLAN (wireless local area network) and Bluetooth communication technology or an IRDA (infrared data access) interface. The RF low-power interface technology referred to herein should especially be understood to include any IEEE 801.xx standard technology, which description is obtainable from the Institute of Electrical and Electronics Engineers. Moreover, the auxiliary I/O interface 200 as well as the short-range communication interface 180 may each represent one or more interfaces supporting one or more input/output interface technologies and communication interface technologies, respectively. The operating system, specific device software applications or modules, or parts thereof, may be temporarily loaded into a volatile store 150 such as a random access memory (typically implemented on the basis of DRAM (direct random access memory) technology for faster operation). Moreover, received communication signals may also be temporarily stored to volatile memory 150, before permanently writing them to a file system located in the non-volatile memory 140 or any mass storage preferably detachably connected via the auxiliary I/O interface for storing data. It should be understood that the components described above represent typical components of a traditional mobile device 10 embodied herein in the form of a cellular phone. The present invention is not limited to these specific components and their implementation depicted merely for illustration and for the sake of completeness.

An exemplary software application module of the mobile device 10 is a personal information manager application providing PDA functionality including typically a contact manager, calendar, a task manager, and the like. Such a personal information manager is executed by the processor 100, may have access to the components of the mobile device 10, and may interact with other software application modules. For instance, interaction with the voice communication software application allows for managing phone calls, voice mails, etc., and interaction with the data communication software application enables for managing SMS (soft message service), MMS (multimedia service), e-mail communications and other data transmissions. The non-volatile memory 140 preferably provides a file system to facilitate permanent storage of data items on the device including particularly calendar entries, contacts etc. The ability for data communication with networks, e.g. via the cellular interface, the short-range communication interface, or the auxiliary I/O interface enables upload, download, and synchronization via such networks.

The application modules 141 to 149 represent device functions or software applications that are configured to be executed by the processor 100. In most known mobile devices, a single processor manages and controls the overall operation of the mobile device as well as all device functions and software applications. Such a concept is applicable for today's mobile devices. The implementation of enhanced multimedia functionalities includes, for example, reproducing of video streaming applications, manipulating of digital images, and capturing of video sequences by integrated or detachably connected digital camera functionality. The implementation may also include gaming applications with sophisticated graphics and the necessary computational power. One way to deal with the requirement for computational power, which has been pursued in the past, solves the problem for increasing computational power by implementing powerful and universal processor cores. Another approach for providing computational power is to implement two or more independent processor cores, which is a well known methodology in the art. The advantages of several independent processor cores can be immediately appreciated by those skilled in the art. Whereas a universal processor is designed for carrying out a multiplicity of different tasks without specialization to a pre-selection of distinct tasks, a multi-processor arrangement may include one or more universal processors and one or more specialized processors adapted for processing a predefined set of tasks. Nevertheless, the implementation of several processors within one device, especially a mobile device such as mobile device 10, requires traditionally a complete and sophisticated re-design of the components.

In the following, the present invention will provide a concept which allows simple integration of additional processor cores into an existing processing device implementation enabling the omission of expensive complete and sophisticated redesign. The inventive concept will be described with reference to system-on-a-chip (SoC) design. System-on-a-chip (SoC) is a concept of integrating at least numerous (or all) components of a processing device into a single high-integrated chip. Such a system-on-a-chip can contain digital, analog, mixed-signal, and often radio-frequency functions—all on one chip. A typical processing device comprises a number of integrated circuits that perform different tasks. These integrated circuits may include especially microprocessor, memory, universal asynchronous receiver-transmitters (UARTs), serial/parallel ports, direct memory access (DMA) controllers, and the like. A universal asynchronous receiver-transmitter (UART) translates between parallel bits of data and serial bits. The recent improvements in semiconductor technology cause very-large-scale integration (VLSI) integrated circuits to enable a significant growth in complexity, making it possible to integrate numerous components of a system in a single chip. With reference to FIG. 15, one or more components thereof, e.g. the controllers 130 and 170, the memory components 150 and 140, and one or more of the interfaces 200, 180 and 110, can be integrated together with the processor 100 in a signal chip which forms finally a system-on-a-chip (Soc).

Additionally, the device 10 is equipped with a module for scalable encoding 105 and scalable decoding 106 of video data according to the inventive operation of the present invention. By means of the CPU 100 said modules 105, 106 may individually be used. However, the device 10 is adapted to perform video data encoding or decoding respectively. Said video data may be received by means of the communication modules of the device or it also may be stored within any imaginable storage means within the device 10. Video data can be conveyed in a bitstream between the device 10 and another electronic device in a communications network.

In sum, the interpolation scheme, according to the present invention, is performed on a block basis. For each block the operation is performed along a horizontal direction and a vertical direction separately using a one-dimensional interpolation filter. In particular, a prediction operation is carried out on each block based on motion compensated prediction with respect to a reference video frame and a motion vector in order to provide a corresponding block of prediction residues. The update operation is carried out on reference video frame based on motion compensated prediction with respect to the block of prediction residues and a reverse direction of the motion vector. Furthermore, in the update operation, the interpolation filter is determined based on the motion vector and the sample values of sub-pixel are interpolated using the block prediction residues by treating the sample values outside the block of prediction residues to be zero.

Thus, the method and device for encoding a digital video sequence using motion compensated temporal filtering, according to the present invention, include using a prediction module for performing a prediction operation on each block based on motion compensated prediction with respect to a reference video frame and a motion vector in order to provide a corresponding block of prediction residues, and an updating module for updating the video reference frame based on motion compensated prediction with respect to the block of prediction residues and a reverse direction of the motion vector. The updating module includes a software program for determining a filter based on the motion vector and for interpolating sample values of sub-pixel locations using the block of prediction residues by treating sample values outside the block to be zero. The interpolating is for generating an energy distributed interpolation.

The method and device for decoding a digital video sequence from an encoded video sequence, according to the present invention, include using a decoding module for decoding a motion vector of a block and the prediction residues of the block, an updating module for performing an update operation of a reference video frame of the block based on motion compensated prediction with respect to the prediction residues of the block and a reverse direction of the motion vector, and a prediction module for performing a prediction operation on the block based on motion compensated prediction with respect to the reference video frame and the motion vector. The updating module includes a software program for determining a filter based on the motion vector and for interpolating sample values of sub-pixel locations using the block of prediction residues by treating sample values outside the block to be zero. The interpolation is performed along a horizontal direction and a vertical direction separately using a one-dimensional interpolation filter.

A mobile terminal, according to the present invention, may be equipped with an encoder or decoder as described above. The mobile terminal may have both the encoder and the decoder.

Furthermore, the encoding and decoding methods can be carried out by a software application product having a storage medium including a software application. For encoding, the software application includes program code for performing a prediction operation on each block based on motion compensated prediction with respect to a reference video frame and a motion vector in order to provide a corresponding block of prediction residues, and program code for updating the video reference frame based on motion compensated prediction with respect to the block of prediction residues and a reverse direction of the motion vector. The update program code includes program code for determining a filter based on the motion vector and program code for interpolating sample values of sub-pixel locations using the block of prediction residues by treating sample values outside the block to be zero. The interpolation is performed along a horizontal direction and a vertical direction separately using a one-dimensional interpolation filter.

For decoding, the software application includes program code for decoding a motion vector of a block and the prediction residues of the block, program code for performing an update operation of a reference video frame of the block based on motion compensated prediction with respect to the prediction residues of the block and a reverse direction of the motion vector, and program code for performing a prediction operation on the block based on motion compensated prediction with respect to the reference video frame and the motion vector. The program code for updating includes program code for determining a filter based on the motion vector and program code for interpolating sample values of sub-pixel locations using the block of prediction residues by treating sample values outside the block to be zero. The interpolation is performed along a horizontal direction and a vertical direction separately using a one-dimensional interpolation filter.

In general, the encoding method can be carried out by means for performing a prediction operation on each block based on motion compensated prediction with respect to a reference video frame and a motion vector in order to provide a corresponding block of prediction residues, and means for updating the video reference frame based on motion compensated prediction with respect to the block of prediction residues and a reverse direction of the motion vector. The updating means includes means for determining a filter based on the motion vector and means for interpolating sample values of sub-pixel locations using the block of prediction residues by treating sample values outside the block to be zero.

The decoding method can be carried out by means for decoding a motion vector of a block and the prediction residues of the block, means for performing an update operation of a reference video frame of the block based on motion compensated prediction with respect to the prediction residues of the block and a reverse direction of the motion vector, and means for performing a prediction operation on the block based on motion compensated prediction with respect to the reference video frame and the motion vector. The updating means includes means for determining a filter based on the motion vector and means for interpolating sample values of sub-pixel locations using the block of prediction residues by treating sample values outside the block to be zero. The interpolation is performed along a horizontal direction and a vertical direction separately using a one-dimensional interpolation filter.

Although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method of encoding a digital video sequence using motion compensated temporal filtering for providing a bitstream having video data representative of encoded video sequence, the digital video sequence comprising a plurality of frames, wherein each frame comprises an array of pixels which can be divided into a plurality of blocks, said method comprising:
for a block,
performing a prediction operation on said block, based on motion compensated prediction with respect to a reference video frame and motion vector, for providing a corresponding block of prediction residues;
updating said video reference frame based on motion compensated prediction with respect to said block of prediction residues and a reverse direction of said motion vector, wherein said updating comprises:
determining a filter based on the motion vector and
interpolating sample values of sub-pixel locations using said block of prediction residues by treating sample values outside said block of prediction residues to be zero.

2. The method of claim 1, wherein said interpolating is performed along a horizontal direction and a vertical direction separately using one-dimensional interpolation filter.

3. A method of decoding a digital video sequence from video data in a bitstream representative of an encoded video sequence, the encoded video sequence comprising a number of frames, wherein each frame comprises an array of pixels which can be divided into a plurality of blocks, said method comprising:
for a block,
decoding a motion vector and the prediction residues of the block;
performing an update operation on a reference video frame of the block based on motion compensated prediction with respect to the prediction residues of the block and a reverse direction of the motion vector;
performing a prediction operation on the block, based on motion compensated prediction with respect to the reference video frame and the motion vector, wherein said updating comprises:
determining a filter based on the motion vector and
interpolating sample values of sub-pixel locations using said block of prediction residues by treating sample values outside said block of prediction residue to be zero.

4. The method of claim 3, wherein said interpolating is performed along a horizontal direction and a vertical direction separately using one-dimensional interpolation filter.

5. A video encoder for encoding a digital video sequence using motion compensated temporal filtering for providing a bitstream having video data representative of encoded video sequence, the digital video sequence comprising a plurality of frames, wherein each frame comprises an array of pixels which can be divided into a plurality of blocks, said encoder comprising:
a prediction module for performing a prediction operation on each block, based on motion compensated prediction with respect to a reference video frame and motion vector, for providing a corresponding block of prediction residues; and
an updating module for updating said video reference frame based on motion compensated prediction with respect to said block of prediction residues and a reverse direction of said motion vector, wherein said updating module comprises
a software program for determining a filter based on the motion vector and for interpolating sample values of sub-pixel locations using said block of prediction residues by treating sample values outside said block of prediction residues to be zero.

6. The encoder of claim 5, wherein said interpolation is performed along a horizontal direction and a vertical direction separately using one dimensional interpolation filter.

7. A video decoder of decoding a digital video sequence from video data in a bitstream representative of an encoded video sequence, the encoded video sequence comprising a number of frames, wherein each frame comprises an array of pixels which can be divided into a plurality of blocks, said decoder comprising:
a module for decoding a motion vector and the prediction residues of the block;
an updating module for performing an update operation on a reference video frame of the block based on motion compensated prediction with respect to the prediction residues of the block and a reverse direction of the motion vector, and
a prediction module for performing a prediction operation on the block, based on motion compensated prediction with respect to the reference video frame and the motion vector, wherein the updating module comprises a software program for determining a filter based on the motion vector and interpolating sample values of sub-pixel locations using said block of prediction residues by treating sample values outside said block of prediction residue to be zero.

8. The decoder of claim 7, wherein said interpolation is performed along a horizontal direction and a vertical direction separately using one-dimensional interpolation filter.

9. A software application product comprising a storage medium having a software application for use in encoding a digital video sequence using motion compensated temporal filtering for providing a bitstream having video data representative of encoded video sequence, the digital video sequence comprising a plurality of frames, wherein each frame comprises an array of pixels which can be divided into a plurality of blocks, said software application comprising:
program code for performing a prediction operation on each block, based on motion compensated prediction with respect to a reference video frame and motion vector, for providing a corresponding block of prediction residues,
program code for updating said video reference frame based on motion compensated prediction with respect to said block of prediction residues and a reverse direction of said motion vector, wherein said program code for updating comprises
program code for determining a filter based on the motion vector and
program code for interpolating sample values of sub-pixel locations using said block of prediction residues by treating sample values outside said block of prediction residues to be zero.

10. The software application product of claim 9, wherein said interpolation is performed along a horizontal direction and a vertical direction separately using one-dimensional interpolation filter.

11. A software application product comprising a storage medium having a software application for use in decoding a digital video sequence from video data in a bitstream representative of an encoded video sequence, the encoded video sequence comprising a number of frames, wherein each frame comprises an array of pixels which can be divided into a plurality of blocks, said software application comprising:
program code for decoding a motion vector and the prediction residues of each block;
program code for performing an update operation on a reference video frame of the block based on motion compensated prediction with respect to the prediction residues of the block and a reverse direction of the motion vector;
program code for performing a prediction operation on the block, based on motion compensated prediction with respect to the reference video frame and the motion vector, wherein the program code for updating comprises:
program code for determining a filter based on the motion vector and interpolating sample values of sub-pixel locations using said block of prediction residues by treating sample values outside said block of prediction residue to be zero.

12. The software application product of claim 11, wherein said interpolation is performed along a horizontal direction and a vertical direction separately using one-dimensional interpolation filter.

13. A mobile terminal comprising:
an encoder for encoding a digital video sequence using motion compensated temporal filtering, the digital video sequence comprising a plurality of frames, wherein each frame comprises an array of pixels which can be divided into a plurality of blocks, said encoder comprising:
a prediction module for performing a prediction operation on each block, based on motion compensated prediction with respect to a reference video frame and motion vector, for providing a corresponding block of prediction residues; and
an updating module for updating said video reference frame based on motion compensated prediction with respect to said block of prediction residues and a reverse direction of said motion vector, wherein said updating module comprises a software program for determining a filter based on the motion vector and for interpolating sample values of sub-pixel locations using said block of prediction residues by treating sample values outside said block of prediction residues to be zero, wherein the mobile terminal is adapted to provide a bitstream having video data representative of encoded video sequence.

14. The mobile terminal of claim 13, wherein said interpolating is performed along a horizontal direction and a vertical direction separately using one-dimensional interpolation filter.

15. A mobile terminal adapted to receive a digital video sequence from video data in a bitstream representative of an encoded video sequence, the encoded video sequence comprising a number of frames, wherein each frame comprises an array of pixels which can be divided into a plurality of blocks, said mobile terminal comprising:
a module for decoding a motion vector and the prediction residues of the block;
an updating module for performing an update operation on a reference video frame of the block based on motion compensated prediction with respect to the prediction residues of the block and a reverse direction of the motion vector, and a prediction module for performing a prediction operation on the block, based on motion compensated prediction with respect to the reference video frame and the motion vector, wherein the updating module comprises a software program for determining a filter based on the motion vector and interpolating sample values of sub-pixel locations using said block of prediction residues by treating sample values outside said block of prediction residue to be zero.

16. The mobile terminal of claim 15, wherein said interpolating is performed along a horizontal direction and a vertical direction separately using one-dimensional interpolation filter.

17. A device of encoding a digital video sequence using motion compensated temporal filtering for providing a bitstream having video data representative of encoded video sequence, the digital video sequence comprising a plurality of frames, wherein each frame comprises an array of pixels which can be divided into a plurality of blocks, said device comprising:
means for performing a prediction operation on each block, based on motion compensated prediction with respect to a reference video frame and motion vector, for providing a corresponding block of prediction residues; and
means for updating said video reference frame based on motion compensated prediction with respect to said block of prediction residues and a reverse direction of said motion vector, wherein the updating means comprises:
means for determining a filter based on the motion vector, and
means for interpolating sample values of sub-pixel locations using said block of prediction residues by treating sample values outside said block of prediction residues to be zero.

18. The device of claim 17, wherein said interpolation is performed along a horizontal direction and a vertical direction separately using one-dimensional interpolation filter.

19. A device for decoding a digital video sequence from video data in a bitstream representative of an encoded video sequence, the encoded video sequence comprising a number of frames, wherein each frame comprises an array of pixels which can be divided into a plurality of blocks, said device comprising:
means for decoding a motion vector and the prediction residues of each block;
means for performing an update operation on a reference video frame of the block based on motion compensated prediction with respect to the prediction residues of the block and a reverse direction of the motion vector; and
means for performing a prediction operation on the block, based on motion compensated prediction with respect to the reference video frame and the motion vector, wherein the updating means comprises:
means for determining a filter based on the motion vector, and
means for interpolating sample values of sub-pixel locations using said block of prediction residues by treating sample values outside said block of prediction residue to be zero.

20. The device of claim 19, wherein said interpolation is performed along a horizontal direction and a vertical direction separately using one-dimensional interpolation filter.
